(19) United States
(12) Patent Application Publication
(10) Pub. No.: US 2025/0377317 A1
(43) Pub. Date: Dec. 11, 2025

(54) X-RAY INSPECTION DEVICE AND OPERATING METHOD THEREOF

(71) Applicant: SK On Co., Ltd., Seoul (KR)

(72) Inventors: Eun Jin CHO, Daejeon (KR); Sang Ki KIM, Daejeon (KR); Joo Yeong KIM, Daejeon (KR); Jin Ho YU, Daejeon (KR); Min Gyu LEE, Daejeon (KR); Byoung Hak LEE, Daejeon (KR)

(21) Appl. No.: 19/228,752

(22) Filed: Jun. 5, 2025

(30) Foreign Application Priority Data
Jun. 7, 2024 (KR) 10-2024-0074441

(51) Int. Cl. G01N 23/083; G01N 23/04; H01M 10/42

(52) U.S. Cl. CPC G01N 23/083; G01N 23/04; H01M 10/4285; G01N 2223/646

(57) ABSTRACT

An X-ray inspection device according the present disclosure includes an X-ray output part irradiating X-rays, an X-ray detector disposed at an opposing position of the X-ray output part and detecting the X-rays to obtain a plurality of gray values, an alignment part assisting in alignment between the X-ray output part and the X-ray detector, a transfer part transferring a battery in a predetermined direction to generate an X-ray image, a signal processor acquiring the X-ray image including the plurality of gray values, and an inspector determining whether the X-ray output part and the X-ray detector are aligned with each other by using the X-ray image of the alignment part.

### CROSS-REFERENCE TO RELATED PATENT APPLICATION

The present application claims priority under 35 U.S.C. § 119(a) to Korean patent application number 10-2024-0074441 filed on Jun. 7, 2024 in the Korean Intellectual Property Office, the entire disclosure of which is incorporated by reference herein.

### BACKGROUND OF THE INVENTION

### 1. Field

The present disclosure relates to an X-ray inspection device and an operating method thereof.

### 2. Description of the Related Art

Recently, with the increasing demand for mobile devices such as smartphones, tablet PCs, and wireless earphones, as well as the development of electric vehicles, storage batteries for energy storage, robots, and satellites, research on high-performance batteries that can be repeatedly charged and discharged as an energy source has been actively conducted.

A battery may include a cathode, an anode, and a separator disposed therebetween. The cathode, the separator, and the anode may be stacked sequentially through a stacking process. During the stacking process, electrode misalignment may occur, causing the alignment position of the electrodes to deviate from the specifications. As a result, the cathode and the anode may come into direct contact, causing a short circuit, which may lead to battery failure or damage, or ignition.

In order to ensure the stability and durability of batteries, a technology that can quickly and accurately detect defects in the alignment of electrodes is required. X-ray inspection methods can be used to inspect the exterior and interior without causing damage to items, but X-ray imaging with an X-ray output part and an X-ray detector aligned with each other allows for precise inspection.

### SUMMARY OF THE INVENTION

An aspect of the present disclosure is to provide an X-ray inspection device capable of performing a precise battery inspection by aligning an X-ray output part with an X-ray detector.

Meanwhile, an X-ray inspection device and an operating method thereof according to the present disclosure may be widely applied in the fields of electric vehicles, battery charging stations, and other green technologies such as photovoltaics and wind power using batteries. In addition, the present disclosure may be used in eco-friendly mobility, including electric vehicles and hybrid vehicles, to prevent climate change by suppressing air pollution and greenhouse fluid emissions.

An X-ray inspection device according to embodiments of the present disclosure may include an X-ray output part irradiating X-rays, an X-ray detector disposed at an opposing position of the X-ray output part and detecting the X-rays to obtain a plurality of gray values, an alignment part assisting in alignment between the X-ray output part and the X-ray detector, a transfer part transferring a battery in a predetermined direction to generate an X-ray image, a signal processor acquiring the X-ray image including the plurality of gray values, and an inspector determining whether the X-ray output part and the X-ray detector are aligned with each other by using the X-ray image of the alignment part, wherein the alignment part comprises: a first jig member removably coupled to one surface of the X-ray detector and including a laser module irradiating a laser in a direction from a center of the X-ray detector to a location of the X-ray output part, and a second jig member removably coupled to one surface of the transfer part and including a metal line indicating a region of interest in the battery.

In an embodiment, the X-ray output part may include a shielding case disposed in a direction facing the X-ray detector, and a cross-shaped indicator line may be displayed on the shielding case, and an intersection of the cross-shaped indicator line may be located on a center of the X-ray output part.

In an embodiment, the first jig member may irradiate a cross-shaped laser through the laser module in the direction toward the location of the X-ray output part.

In an embodiment, the second jig may include at least two metal balls disposed at predetermined positions and a metal line separating a first region of interest corresponding to an anode tab of the battery from a second region of interest corresponding to a cathode tab of the battery.

In an embodiment, the inspector may determine a magnification by comparing a number of pixels included in each of the at least two metal balls with a reference pixel number in an X-ray image acquired by capturing the second jig member.

In an embodiment, the inspector may determine that the X-ray output part and the X-ray detector are aligned with each other when each of the anode tab and the cathode tab of the battery is included within a reference pixel number in the first and second regions of interest in a first X-ray image captured by arranging the second jig member and the battery to overlap with each other.

In an embodiment, the alignment part further may include a third jig member removably coupled to one surface of the transfer part and including a metal group including metal members spaced apart at predetermined distances.

In an embodiment, the metal group may be disposed at a plurality of locations in each of predetermined regions of the third jig member.

In an embodiment, the metal group may include a first metal member including iron, a second metal member including copper, a third metal member including a same material as a cathode tab of the battery, and a fourth metal member including a same material as an anode tab of the battery.

In an embodiment, the first to fourth metal members may have different areas.

In an embodiment, the third metal member may have a larger area than areas of the first and second metal members.

In an embodiment, the fourth metal member may have a larger area than an area of the third metal member.

In an embodiment, the fourth metal member may be provided as a single fourth metal member and two overlapping fourth metal members.

In an embodiment, the inspector may determine that the X-ray output part and the X-ray detector are aligned with each other when metal members with a same material and a same thickness have a gray value within a reference range in a second X-ray image acquired by capturing the third jig member.

An operating method of an X-ray inspection device according to embodiments of the present disclosure may include acquiring a first X-ray image by arranging a second jig member and a battery to overlap with each other, primarily determining whether each of an anode tab area and a cathode tab area of the battery is included within a reference pixel number in first and second regions of interest separated by a metal line of the second jig member in the first X-ray image, secondarily determining whether metal members with a same material and a same thickness have a gray value within a reference range in a second X-ray image acquired by capturing a third jig member, and determining that the X-ray detector and the X-ray output part are aligned with each other for X-ray imaging when primary and secondary aligning determinations satisfy criteria.

### BRIEF DESCRIPTION OF THE DRAWINGS

FIG. 1 is a diagram illustrating an X-ray inspection device according to an embodiment of the present disclosure.

FIG. 2 is a diagram illustrating an alignment part according to an embodiment of the present disclosure.

FIG. 3 is a diagram illustrating an X-ray detector according to an embodiment of the present disclosure.

FIGS. 4A, 4B, and 4C are diagrams illustrating a first jig member according to an embodiment of the present disclosure.

FIGS. 5A and 5B are diagrams illustrating a second jig member according to an embodiment of the present disclosure.

FIG. 6 is a diagram illustrating a first X-ray image according to an embodiment of the present disclosure.

FIGS. 7A, 7B, and 7C are diagrams illustrating a third jig member according to an embodiment of the present disclosure.

FIG. 8 is a diagram illustrating a method of operating an X-ray inspection device according to an embodiment of the present disclosure.

### DETAILED DESCRIPTION

Advantages and features of the present invention and methods for achieving them will be made clear from embodiments described below in detail with reference to the accompanying drawings. However, they may be embodied in different forms and should not be construed as limited to the embodiments set forth herein. Rather, these embodiments are provided so that this disclosure will be thorough and complete, and will fully convey the scope of the invention to those skilled in the art. The scope of the present invention is defined solely by the claims.

The terminology used herein is for the purpose of describing particular embodiments only and is not intended to be limiting. It will be further understood that the terms “comprises” and/or “comprising” when used in this specification specify the presence of stated components, but do not preclude the presence or addition of one or more other components. As used herein, the term “and/or” includes any and all combinations of one or more of the associated listed items. In this specification, like reference numerals have been used for like elements. It will be understood that, although the terms “first”, “second”, etc. may be used herein to describe various elements, these elements should not be limited by these terms. These terms are only used to distinguish one element from another element. Therefore, a first element discussed below could be termed a second element without departing from the scope of the invention.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

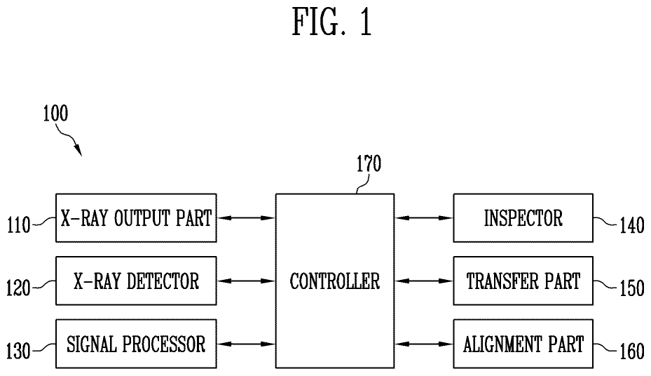

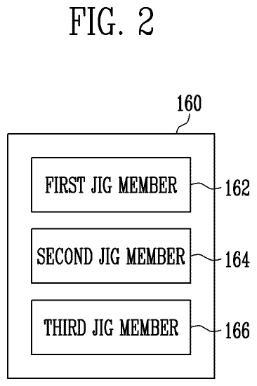

FIG. 1 is a diagram illustrating an x-ray inspection device 100 according to an embodiment of the present disclosure, and FIG. 2 is a diagram illustrating an alignment part 160 according to an embodiment of the present disclosure.

Referring to FIGS. 1 and 2, the X-ray inspection device 100 according to an embodiment may include an X-ray output part 110, an X-ray detector 120, a signal processor 130, an inspector 140, a transfer part 150, the alignment part 160, and a controller 170.

The X-ray output part 110 may generate X-rays. The X-rays may be electromagnetic waves having the property of penetrating an object. For example, the X-rays may be electromagnetic waves having a wavelength of 0.01 nm to 10 nm.

In an embodiment, the X-ray output part 110 may include an X-ray tube, a voltage generator, and a current source.

In an embodiment, the X-ray inspection device may comprise an X-ray output part irradiating X-rays, an X-ray detector disposed at an opposing position of the X-ray output part and detecting the X-rays to obtain a plurality of gray values, an alignment part assisting in alignment between the X-ray output part and the X-ray detector, a transfer part transferring a battery in a predetermined direction to generate an X-ray image, a signal processor acquiring the X-ray image including the plurality of gray values, and an inspector determining whether the X-ray output part and the X-ray detector are aligned with each other by using the X-ray image of the alignment part. For example, the alignment part may comprise a first jig member removably coupled to one surface of the X-ray detector and including a laser module irradiating a laser in a direction from a center of the X-ray detector to a location of the X-ray output part; and a second jig member removably coupled to one surface of the transfer part and including a metal line indicating a region of interest in the battery.

The X-ray tube may include an anode, a cathode, and a vacuum tube. The anode and the cathode may be disposed within the vacuum tube. For example, each of the anode and the cathode may include a metal or an alloy thereof, such as tungsten (W), molybdenum (Mo), chromium (Cr), rhenium (Re), copper (Cu), cobalt (Co), iron (Fe), tantalum (Ta), zirconium (Zr), nickel (Ni), and the like. The X-ray tube may be of one of two types: a closed type having a structure in which the inside of the vacuum tube is sealed under vacuum, and an open type having a structure in which the inside of the vacuum tube is kept under vacuum when a separate vacuum pump is operated. When the X-ray output part 110 has an open type structure, the X-ray output part 110 may further include a vacuum pump. The vacuum pump may create a vacuum inside the vacuum tube.

The current source may apply a current to heat the filament of the anode, generating thermal electrons at the anode. The voltage generator may accelerate thermal electrons by applying a high voltage between the cathode and the anode. For example, the high voltage may be a voltage in kV. The accelerated heat electrons may strike the cathode and generate X-rays. A test object may be irradiated with the generated X-rays.

The X-ray output part 110 may irradiate the battery with X-rays. The battery may be a secondary battery which is reusable by charging even after being discharged. For example, the battery may be a lithium-ion battery. The battery may include a plurality of electrode layers and a separator disposed between the plurality of electrode layers. The plurality of electrode layers may include at least one anode layer and at least one cathode layer.

The X-ray detector 120 may be disposed at an opposing position of the X-ray output part 110. The X-ray detector 120 may acquire a plurality of gray values based on the X-rays which have penetrated the battery. The gray values may be inversely proportional to the intensity of the X-rays. For example, the lower the intensity of the X-rays, the higher the gray value may be obtained.

In an embodiment, the inspector may determine a magnification by comparing a number of pixels included in each of the at least two metal balls with a reference pixel number in an X-ray image acquired by capturing the second jig member.

For example, the X-ray detector 120 may include a plurality of pixels. The plurality of pixels may be arranged in row and column directions. The pixels may detect X-rays which have penetrated a unit area of the battery to obtain a sensing signal.

In an embodiment, a pixel may include a photo-conductor which converts X-rays directly into an electrical signal. In another embodiment, a pixel may include a scintillator which converts X-rays to visible light and a photo-diode which converts visible light to an electrical signal.

The X-ray detector 120 may include a pixel operation section. The pixel operation section may convert a sensing signal into a digital value to obtain a gray value. The number of gray values may be equal to or proportional to the number of pixels.

In an embodiment, the X-ray detector 120 may acquire gray values using a time delay integration (TDI) method or a flat panel detection (FPD) method.

The signal processor 130 may acquire an X-ray image. The X-ray image may include a plurality of gray values. The plurality of gray values may be arranged according in the row and column directions in the X-ray image. Each of the gray values may represent a unit area of the battery.

The signal processor 130 may receive gray values from the X-ray detector 120 and acquire an X-ray image including the received gray values. For example, when the signal processor 130 receives gray values per line (or region) from the X-ray detector 120, the signal processor 130 may arrange the currently received gray values on different lines (or regions) such that the current gray values may not overlap on the lines (or regions) on which the previously received gray values are arranged. The signal processor 130 may generate an X-ray image including the gray values arranged in each line (or region). A line may represent a single row or a single column. A region may include a plurality of lines.

The inspector 140 may determine a region corresponding to the battery within the X-ray image.

In an embodiment, the inspector 140 may determine a region corresponding to the battery based on a predetermined pattern included in the X-ray image. For example, a region corresponding to the battery may be determined based on a pattern corresponding to the outer contour of the battery.

In another embodiment, the inspector 140 may determine a region corresponding to the battery based on a change in gray value in a predetermined direction within the X-ray image. For example, straight lines may be drawn in the top-to-bottom, bottom-to-top, left-to-right, and right-to-left directions on a two-dimensional X-ray image, and a region corresponding to the battery may be set by finding points where the gray value changes rapidly in each direction.

In an embodiment, the inspector determines that the X-ray output part and the X-ray detector are aligned with each other when each of the anode tab and the cathode tab of the battery is included within a reference pixel number in the first and second regions of interest in a first X-ray image captured by arranging the second jig member and the battery to overlap with each other.

For example, the inspector 140 may perform an alignment check of the X-ray inspection device 100 prior to inspecting the battery for defects. The inspector 140 may analyze the X-ray image to determine whether the X-ray output part 110 and the X-ray detector 120 are aligned with each other.

In an embodiment, the inspector 140 may analyze a first X-ray image to determine whether the X-ray output part 110 and the X-ray detector 120 are aligned with each other. The first X-ray image is acquired by imaging a second jig member 164 of the alignment part 160. The first X-ray image may include first and second regions of interest formed by the second jig member 164. The inspector 140 may determine whether in each of the first and second regions of interest, anode and cathode tabs of the battery are included within a reference number of pixels. When both the anode tab and the cathode tab are included within the reference number of pixels, the inspector 140 may determine that the X-ray output part 110 and the X-ray detector 120 are aligned with each other.

In an embodiment, the inspector may determine that the X-ray output part and the X-ray detector are aligned with each other when metal members with a same material and a same thickness have a gray value within a reference range in a second X-ray image acquired by capturing the third jig member.

In another embodiment, the inspector 140 may analyze a second X-ray image to determine whether the X-ray output part 110 and the X-ray detector 120 are aligned with each other. The second X-ray image is acquired by imaging a third jig member 166 of the alignment part 160. The inspector 140 may analyze gray values of metal members in the second X-ray image. The inspector 140 may determine that the X-ray output part 110 and the X-ray detector 120 are aligned with each other when the metal members with the same material and the same thickness in the second X-ray image have gray values within a reference range.

Once the aligning test is complete, the inspector 140 may analyze anode and cathode regions of the X-ray image to determine whether the battery is defective. The anode region may include gray values indicating an anode layer. The cathode region may include gray values representing a cathode layer. For example, the cathode region may represent a region where the anode and cathode layers are stacked together, and each of the gray values included in the cathode region may be 30.

For example, an anode region may represent a region in which an anode layer and a cathode layer are stacked together, and each of the gray values included in the anode region may be 15. The inspector 140 may determine that the region including the gray value of 30 is the cathode region, and the region including the gray value of 15 is the anode region. However, this is only an embodiment, and the gray values included in the cathode region or the anode region may vary.

The transfer part 150 may move the battery in a predetermined direction. For example, the predetermined direction may be a horizontal direction. For example, the predetermined direction may be in an X-axis direction. In an embodiment, the transfer part 150 may include a conveyor and a transfer motor. The transfer motor may transmit a rotational force to the conveyor. The conveyor may move a battery located at a predetermined point on the conveyor to another point when the rotational force is transmitted.

In an embodiment, the first jig member may irradiate a cross-shaped laser through the laser module in the direction toward the location of the X-ray output part.

In an embodiment, the alignment part further comprises a third jig member removably coupled to one surface of the transfer part and including a metal group including metal members spaced apart at predetermined distances.

For example, the alignment part 160 may include a first jig member 162 removably coupled to one surface of the X-ray detector 120, and the second and third jig members 164 and 166 removably coupled to one surface of the transfer part 150. The alignment part 160 may utilize the first, second, and third jig members 162, 164, and 166 to assist in alignment between the X-ray output part 110 and the X-ray detector 120.

The first jig member 162 may include a first flat panel member, a first connecting member, and a laser module. The first jig member 162 may be fixedly disposed in a position facing one surface of the X-ray detector 120 using the first connecting member. One surface of the first flat panel member may be disposed to face one surface of the X-ray detector 120. The laser module may be disposed on the other side of the first flat panel member. The laser module may direct a laser in a direction in which the X-ray output part 110 is located. The laser module may irradiate a laser having a cross shape, but is not limited thereto. The laser module may irradiate a laser with other various shapes, such as a circle, a square, a triangle, polygon consisting of curved and straight lines, etc.

In an embodiment, the second jig may comprise at least two metal balls disposed at predetermined positions and a metal line separating a first region of interest corresponding to an anode tab of the battery from a second region of interest corresponding to a cathode tab of the battery.

For example, the second jig member 164 may include at least two metal balls and a metal line. The second jig member 164 may be fixedly disposed in a position facing one surface of the transfer part 150 using a second connecting member. The metal balls may be spaced apart at predetermined positions on the second jig member 164. The metal line may be disposed at a predetermined position to set a first region of interest and a second region of interest. The first region of interest corresponds to the anode tab of the battery, and the second region of interest corresponds to the cathode tab of the battery. The metal balls and the metal line may be visible in the first X-ray image along with the battery.

In an embodiment, the metal group may be disposed at a plurality of locations in each of predetermined regions of the third jig member.

For example, the third jig member 166 may include a metal group including a plurality of metal members. The third jig member 166 may be fixedly disposed in a position facing one surface of the transfer part 150 using a third connecting member. Metal groups may be disposed at a plurality of positions for each predetermined area of the third jig member 166. Each metal group may include metal members made of different materials.

In an embodiment, a metal group may include a first metal member made of iron, a second metal member made of copper, a third metal member made of the same material as the cathode tab of the battery, and a fourth metal member made of the same material as the anode tab of the battery.

In an embodiment, the first to fourth metal members may include different areas. For example, the second metal member may be provided with a larger area than the first metal member, the third metal member may be provided with a larger area than the second metal member, and the fourth metal member may be provided with a larger area than the third metal member.

In another embodiment, the fourth metal member may be provided as a single fourth metal member and two overlapping fourth metal members. For example, a metal group may include a first metal member, a second metal member, a third metal member, a single fourth metal member, and two fourth metal members arranged in an overlapping configuration.

The controller 170 may control the overall operation of the X-ray inspection device 100. In an embodiment, the controller 170 may control the operation of at least one of the X-ray output part 110, the X-ray detector 120, the signal processor 130, the inspector 140, and the transfer part 150. In an embodiment, the controller 170 may perform data communicating operations or data processing operations. For example, the controller 170 may include a single processor or a plurality of processors.

In an embodiment, the X-ray inspection device 100 may include the X-ray output part 110, the X-ray detector 120, the signal processor 130, the inspector 140, and the controller 170. The X-ray inspection device 100 may be a single inspection device, but this is only an embodiment and may be implemented in a combination of a plurality of electronic devices. For example, a first electronic device may include the X-ray output part 110, the X-ray detector 120, and the controller 170, and a second electronic device may include the signal processor 130 and the inspector 140.

The first electronic device and the second electronic device may transmit and receive data according to various communication specifications. The first electronic device may be implemented in the form of an X-ray inspection facility, and the second electronic device may be implemented in the form of a computer, a laptop computer, a tablet computer, a smartphone, a mobile device, or various other electronic devices. As such, the X-ray inspection device 100 may be implemented as a combination of various electronic devices.

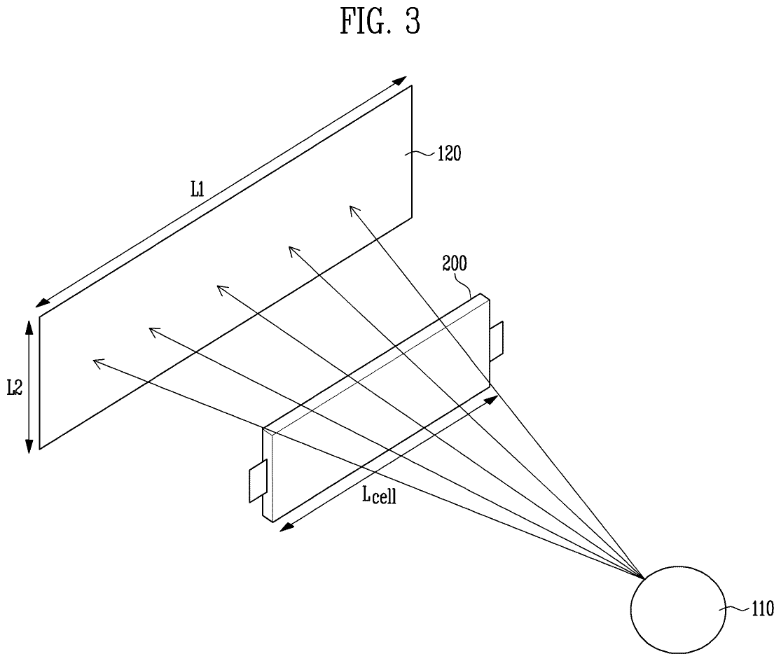

FIG. 3 is a diagram illustrating the X-ray detector 120 according to an embodiment of the present disclosure.

Referring to FIG. 3, the X-ray detector 120 may include a flat panel detector. The flat panel detector may include a pixel array including a plurality of pixels. For example, the pixel array may include pixels arranged in an m×n arrangement.

The pixels may each detect transmitted X-rays which have penetrated a unit area of a battery 200, and may obtain a sensing signal for the transmitted X-rays. For example, the sensing signal may be a charge, current, or voltage. The level of the sensing signal may be indicative of the intensity of the transmitted X-rays. The pixels may correspond to a unit area of the battery 200.

In an embodiment, the level of the sensing signal may be inversely proportional to the intensity of the X-rays. For example, a lower intensity of the X-rays may result in a greater level of sensing signal. In another embodiment, the level of the sensing signal may be proportional to the intensity of the X-rays.

In an embodiment, the pixels may include a photo-conductor which converts X-rays directly into an electrical signal. In another embodiment, the pixels may include a scintillator which converts X-rays to visible light and a photo-diode which converts visible light to an electrical signal.

In an embodiment, the X-ray detector 120 may include a pixel operation section. The pixel operation section may receive a sensing signal and obtain a gray value corresponding to a level of the sensing signal. For example, the pixel computing part may include an analog-to-digital converter which converts an analog signal to a digital signal.

In an embodiment, a first length L1 of the flat panel detector may be less than a length Lcell of the battery 200 in a tab protrusion direction. Accordingly, the entire image of the battery 200 may be acquired by acquiring a plurality of images of the battery 200 by moving the battery 200 in one direction using the transfer part 150. In other words, an X-ray image of the battery 200 may be acquired by merging the plurality of images acquired while moving the battery 200.

In another embodiment, the first length L1 of the flat panel detector may be greater than the length Lcell of the battery 200 in the tab protrusion direction. Further, the first length L1 of the flat panel detector may be greater than a second length L2 of the flat panel detector.

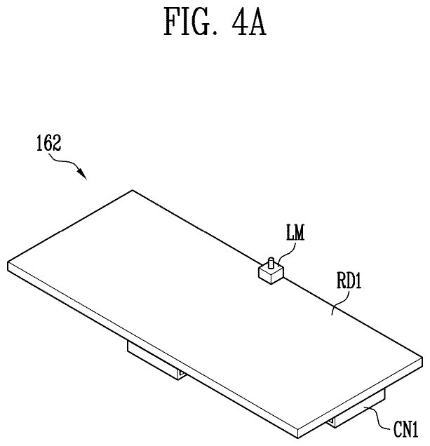

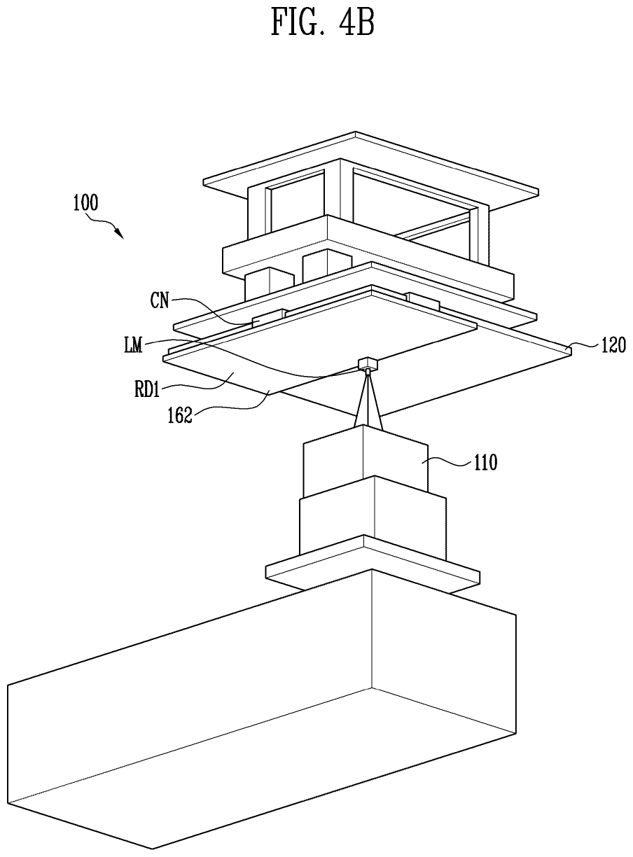

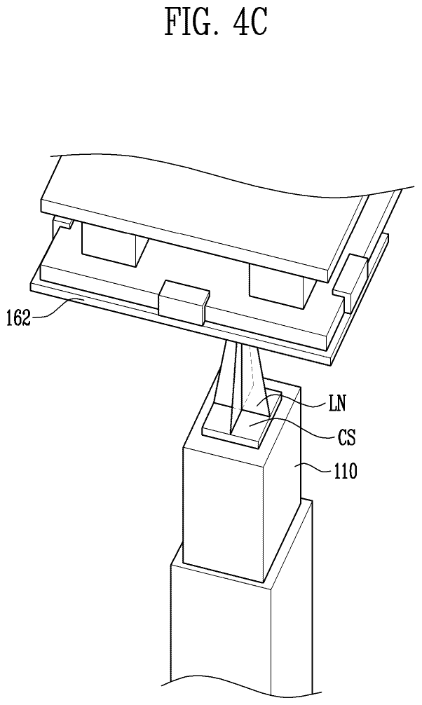

FIGS. 4A, 4B, and 4C are diagrams illustrating the first jig member 162 according to an embodiment of the present disclosure.

Referring to FIG. 4A, the first jig member 162 may include a first flat panel member RD1, a first connecting member CN1, and a laser module LM. The first flat panel member RD1 may include a material which is capable of transmitting X-rays. For example, the first flat panel member RD1 may include, but is not limited to, a carbon fiber composite, aluminum, acrylic, or the like, and other known materials capable of transmitting X-rays may be used.

The first connecting member CN1 may be disposed on at least one side of the first flat panel member RD1. The first connecting member CN1 may be fixedly coupled to the X-ray detector 120 or another configuration of the X-ray inspection device 100. For example, the first connecting member CN1 may be coupled through bolt/nut fastening, snap-fit, rivet fastening, and other methods. However, the present disclosure is not limited thereto, and other know coupling methods may be used.

The laser module LM may be disposed on one surface of the first flat panel member RD1. The laser module LM may irradiate a cross-shaped laser, but is not limited thereto, and the laser module LM may irradiate a laser with various other shapes, including circles, squares, triangles, and polygons including curved and straight lines.

Referring to FIGS. 4B and 4C, the first jig member 162 may be fixedly disposed in a position facing one surface of the X-ray detector 120 using the first connecting member CN1. One surface of the first flat panel member RD1 may be disposed to face the one surface of the X-ray detector 120. On the other side of the first flat panel member RD1, the laser module LM may be disposed. The laser module LM may irradiate a laser in the shape of a cross in the direction in which the X-ray output part 110 is located.

In an embodiment, the X-ray output part may comprise a shielding case disposed in a direction facing the X-ray detector, and a cross-shaped indicator line may be displayed on the shielding case, and an intersection of the cross-shaped indicator line may be located on a center of the X-ray output part.

For example, the X-ray output part 110 may include a shielding case CS disposed on a surface in a position facing the X-ray detector 120. The shielding case CS may be marked with an indicator line LN of a shape corresponding to the shape of the laser module LM. For example, when the laser module LM irradiates with a cross-shaped laser, the shielding case of the X-ray output part 110 may be marked with the cross-shaped indicator line LN. The intersection point of the cross-shaped indicator line LN may be disposed on the center of the X-ray output part 110 from which X-rays are output.

The X-ray output part 110 and the X-ray detector 120 may be determined to be aligned with each other when the laser in the shape of the cross and the indicator line LN in the shape of a cross are aligned with each other.

When the cross-shaped laser and the cross-shaped indicator line LN are not aligned with each other, a user of the X-ray inspection device 100 may horizontally move the position of the X-ray output part 110. When the horizontal movement of the X-ray output part 110 causes the cross-shaped laser and the cross-shaped indicator line LN to be aligned with each other, the alignment inspection by the first jig member 162 may be terminated.

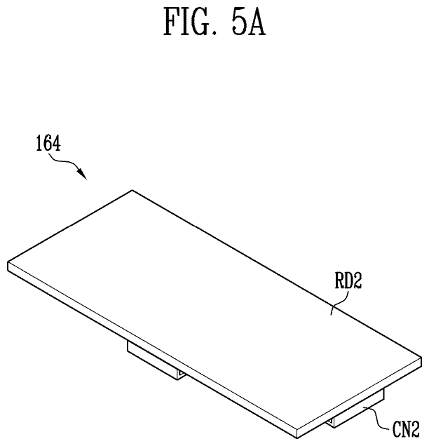

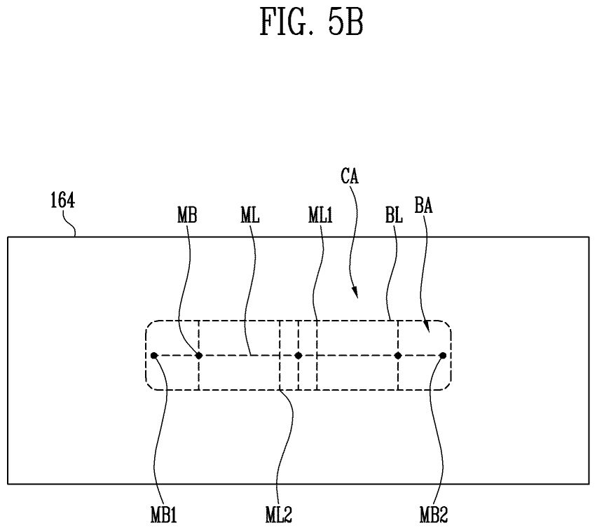

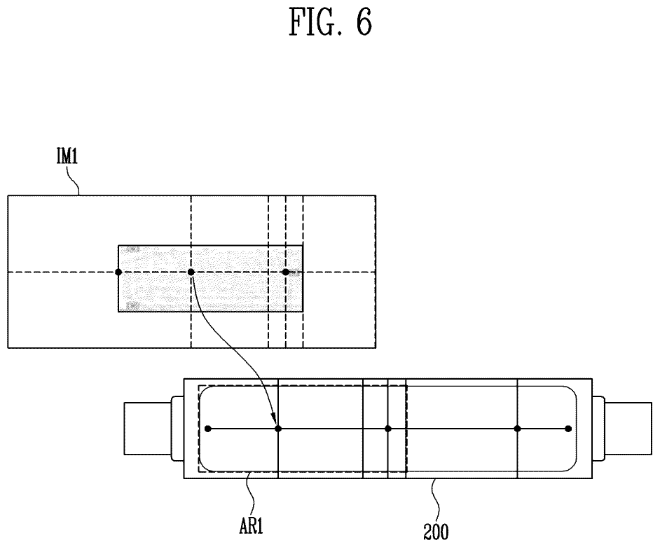

FIGS. 5A and 5B are diagrams illustrating the second jig member 164 according to an embodiment of the present disclosure, and FIG. 6 is a diagram illustrating a first X-ray image according to an embodiment of the present disclosure.

Referring to FIGS. 5A and 5B, the second jig member 164 may include a second flat panel member RD2 and a second connecting member CN2. The second flat panel member RD2 may include a material which is capable of transmitting X-rays. For example, the second flat panel member RD2 may include, but is not limited to, a carbon fiber composite, aluminum, acrylic, or the like, and other known materials capable of transmitting X-rays may be used.

The second connecting member CN2 may be disposed on at least one side of the second flat panel member RD2. The second connecting member CN2 may be fixedly coupled to the transfer part 150 or another configuration of the X-ray inspection device 100. The second jig member 164 may be fixedly disposed in a position facing one surface of the transfer part 150 using the second connecting member CN2. However, the present disclosure is not limited thereto, and the second jig member 164 may be disposed on the transfer part 150 without being coupled to the transfer part 150.

One surface of the second flat panel member RD2 may be disposed to face one surface of the X-ray detector 120.

At least two metal balls MB and a metal line ML may be disposed on the second flat panel member RD2. The metal balls MB may be spaced apart at predetermined locations on the second jig member 164. The metal balls MB and the metal line ML may be disposed in a battery area BA. The battery area BA is separated from a shielding area CA by a boundary line BL. The battery area BA is not shield from X-rays by a collimator disposed in the X-ray output part 110. The shielding area CA is shielded from X-rays by the collimator of the X-ray output part 110.

The metal line ML may be disposed at a predetermined location within the battery area BA to set a first region of interest and a second region of interest. The first region of interest corresponds to the anode tab of the battery 200, and the second region of interest corresponds to the cathode tab of the battery 200. For example, the region between a first metal line ML1 and a first metal ball MB1 may be set as the first region of interest. The region between a second metal line ML2 and a second metal ball MB2 may be set as the second region of interest.

According to an embodiment, the metal line ML may be disposed at predetermined locations within the battery area BA to set a first region of interest, a second region of interest, and a third region of interest. The first region of interest may correspond to the anode tab of the battery 200, the second region of interest may correspond to the cathode tab of the battery, and the third region of interest may correspond to the center of the battery cell.

FIG. 6 shows a first X-ray image IM1 taken with the second jig member 164 and the cathode tab of the battery 200 overlapped with each other. In the first X-ray image IM1, the metal balls MB and the metal line ML may be displayed along with the cathode tab of the battery 200.

The inspector 140 may determine a region corresponding to the battery 200 in the first X-ray image IM1.

In an embodiment, the inspector 140 may determine a region corresponding to the battery 200 based on a predetermined pattern included within the first X-ray image IM1. For example, a region corresponding to the battery 200 may be set based on a pattern corresponding to an outer contour of the battery 200. The inspector 140 may determine whether the region corresponding to the cathode tab of the battery 200 is included within a reference number of pixels in a first region of interest AR1.

In another embodiment, the inspector 140 may determine a region corresponding to the battery 200 based on a change in gray value in a predetermined direction within the first X-ray image IM1. For example, straight lines may be drawn on the first X-ray image IM1 in the top-to-bottom, bottom-to-top, left-to-right, and right-to-left directions, and the region corresponding to the battery 200 may be set by finding points where the gray value changes rapidly in each direction. The inspector 140 may determine if the area corresponding to the cathode tab of the battery 200 is included within the reference number of pixels in the first region of interest AR1.

In this manner, the inspector 140 may determine whether the region corresponding to the anode tab of the battery 200 is included within the reference number of pixels in the second region of interest.

The inspector 140 may determine that the X-ray output part 110 and the X-ray detector 120 are aligned with each other when each of the anode and cathode tabs of the battery 200 is included within the reference number of pixels in the first and second regions of interest.

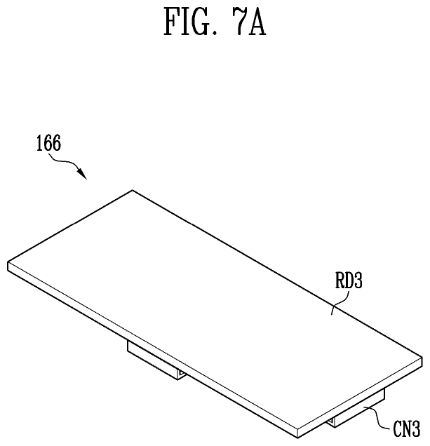

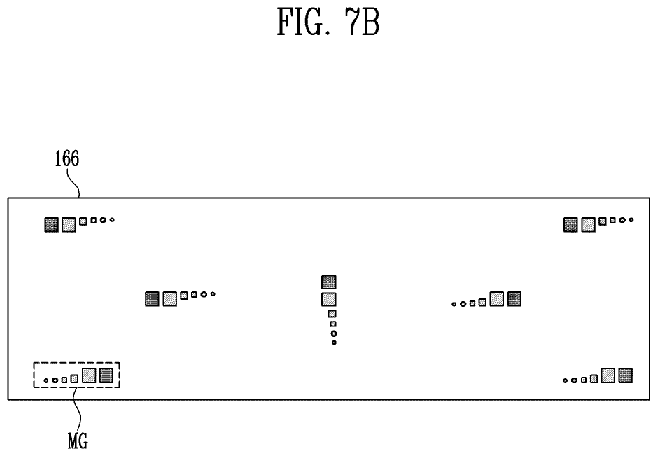

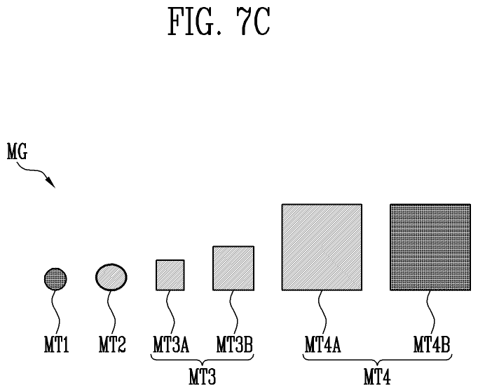

FIGS. 7A, 7B, and 7C are diagrams illustrating the third jig member 166 according to an embodiment of the present disclosure.

Referring to FIG. 7A, the third jig member 166 may include a third flat panel member RD3 and a third connecting member CN3. The third flat panel member RD3 may be provided with an X-ray transmissive material. For example, the third flat panel member RD3 may include, but is not limited to, a carbon fiber composite, aluminum, acrylic, or the like, and other known materials capable of transmitting X-rays may be used.

The third connecting member CN3 may be disposed on at least one side of the third flat panel member RD3. The third connection member CN3 may be fixedly coupled to the transfer part 150 or another configuration of the X-ray inspection device 100. The third jig member 166 may be fixedly disposed in a position facing one surface of the transfer part 150 with the third connecting member CN3. However, the present disclosure is not limited thereto, and the third jig member 166 may also be disposed on the transfer part 150 without being coupled to the transfer part 150.

One surface of the third flat panel member RD3 may be disposed to face one surface of the X-ray detector 120.

Referring to FIGS. 7B, and 7C, the metal groups MG may be disposed at a plurality of locations in each of the predetermined regions of the third flat panel member RD3. Each metal group MG may include metal members made of different materials.

In an embodiment, the metal group MG may include a first metal member MT1 made of iron, a second metal member MT2 made of copper, a third metal member MT3 made of the same material as the cathode tab of the battery 200, and a fourth metal member MT4 made of the same material as the anode tab of the battery 200.

In another embodiment, the first, second, third, and to fourth metal members MT1, MT2, MT3, and MT4 may have different areas. For example, the second metal member MT2 may be provided with a larger area than the first metal member MT1, the third metal member MT3 may be provided with a larger area than the second metal member MT2, and the fourth metal member MT4 may be provided with a larger area than the third metal member MT3.

In another embodiment, the fourth metal member MT4 may be provided as a single fourth metal member MT4A and two overlapping fourth metal members MT4B. For example, the metal group MG may include the first metal member MT1, the second metal member MT2, the third metal member MT3, a single disposed fourth metal member MT4A, and two stacked fourth metal members MT4B.

The inspector 140 may compare gray values of metal members having the same material and the same thickness in a second X-ray image to each other. The second X-ray image is acquired by imaging the third jig member 166. When the gray values of the metal members having the same material and the same thickness all are within a reference range, the inspector 140 may determine that the X-ray output part 110 and the X-ray detector 120 are aligned with each other. For example, in the second X-ray image, when the first metal member MT1 has a gray value within the reference range, the second metal member MT2 has a gray value within the reference range, and the third metal member MT3 has a gray value within the reference range, a single fourth metal member MT4A has a gray value within the reference range, and two overlapping fourth metal members MT4B have a gray value within the reference range, the inspector 140 may determine that the X-ray output part 110 and the X-ray detector 120 are aligned with each other.

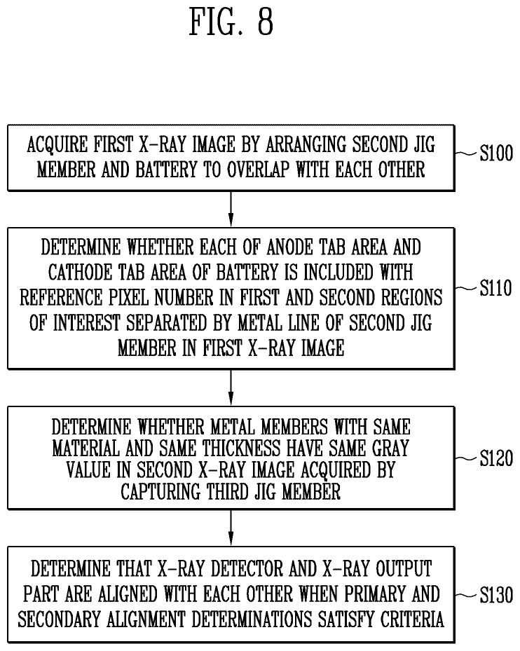

FIG. 8 is a diagram illustrating a method of operating the X-ray inspection device 100 according to an embodiment of the present disclosure.

In an embodiment, an operating method of an X-ray inspection device may comprise acquiring a first X-ray image by arranging a second jig member and a battery to overlap with each other, primarily determining whether each of an anode tab area and a cathode tab area of the battery is included within a reference pixel number in first and second regions of interest separated by a metal line of the second jig member in the first X-ray image, secondarily determining whether metal members with a same material and a same thickness have a gray value within a reference range in a second X-ray image acquired by capturing a third jig member; and determining that the X-ray detector and the X-ray output part are aligned with each other for X-ray imaging when primary and secondary aligning determinations satisfy criteria.

For example, referring to FIG. 8, the X-ray inspection device 100 may irradiate a cross-shaped laser through the laser module LM disposed on the first jig member 162 in the direction from the center of the X-ray detector 120 to the direction in which the X-ray output part 110 is located. The user of the X-ray inspection device 100 may adjust the horizontal position of the X-ray output part 110 so that the cross-shaped indicator line marked on the shielding case CS of the X-ray output part 110 may coincide with the cross-shaped laser.

The X-ray inspection device 100 may then acquire the first X-ray image IM1 by arranging the second jig member 164 and the battery 200 to overlap with each other at step S100.

The X-ray inspection device 100 may primarily determine whether each of an anode tab area and a cathode tab area of the battery 200 is included within a reference number of pixels in the first and second regions of interest separated by the metal line ML of the second jig member 164 in the first X-ray image IM1 at step S110.

The X-ray inspection device 100 may secondarily determine whether the metal members provided with the same material and the same thickness in the second X-ray image acquired by capturing the third jig member 166 have gray values within a reference range at step S120.

In addition, the X-ray inspection device 100 may determine that the X-ray detector 120 and the X-ray output part 110 are aligned with each other for X-ray imaging when the primary and secondary alignment checks are determined to satisfy the criteria at step S130.

According to one aspect of the present disclosure, an X-ray inspection device capable of performing a precise battery inspection by aligning an X-ray output part with an X-ray detector may be provided.

The present disclosure may be modified and implemented in various forms, and its scope is not limited to the above-described embodiments. The content described above is merely an example of applying the principles of the present disclosure, and other features may be further included without departing from the scope of embodiments according to the present disclosure.

What is claimed is:

1. An X-ray inspection device, comprising:
an X-ray output part irradiating X-rays;
an X-ray detector disposed at an opposing position of the X-ray output part and detecting the X-rays to obtain a plurality of gray values;
an alignment part assisting in alignment between the X-ray output part and the X-ray detector;
a transfer part transferring a battery in a predetermined direction to generate an X-ray image;
a signal processor acquiring the X-ray image including the plurality of gray values; and
an inspector determining whether the X-ray output part and the X-ray detector are aligned with each other by using the X-ray image of the alignment part,
wherein the alignment part comprises:
a first jig member removably coupled to one surface of the X-ray detector and including a laser module irradiating a laser in a direction from a center of the X-ray detector to a location of the X-ray output part; and
a second jig member removably coupled to one surface of the transfer part and including a metal line indicating a region of interest in the battery.

2. The X-ray inspection device according to claim 1, wherein the X-ray output part comprises a shielding case disposed in a direction facing the X-ray detector, and
wherein a cross-shaped indicator line is displayed on the shielding case, and an intersection of the cross-shaped indicator line is located on a center of the X-ray output part.

3. The X-ray inspection device according to claim 1, wherein the first jig member irradiates a cross-shaped laser through the laser module in the direction toward the location of the X-ray output part.

4. The X-ray inspection device according to claim 1, wherein the second jig comprises at least two metal balls disposed at predetermined positions and a metal line separating a first region of interest corresponding to an anode tab of the battery from a second region of interest corresponding to a cathode tab of the battery.

5. The X-ray inspection device according to claim 4, wherein the inspector determines a magnification by comparing a number of pixels included in each of the at least two metal balls with a reference pixel number in an X-ray image acquired by capturing the second jig member.

6. The X-ray inspection device according to claim 4, wherein the inspector determines that the X-ray output part and the X-ray detector are aligned with each other when each of the anode tab and the cathode tab of the battery is included within a reference pixel number in the first and second regions of interest in a first X-ray image captured by arranging the second jig member and the battery to overlap with each other.

7. The X-ray inspection device according to claim 1, wherein the alignment part further comprises a third jig member removably coupled to one surface of the transfer part and including a metal group including metal members spaced apart at predetermined distances.

8. The X-ray inspection device according to claim 7, wherein the metal group is disposed at a plurality of locations in each of predetermined regions of the third jig member.

9. The X-ray inspection device according to claim 7, wherein the metal group comprises a first metal member including iron, a second metal member including copper, a third metal member including a same material as a cathode tab of the battery, and a fourth metal member including a same material as an anode tab of the battery.

10. The X-ray inspection device according to claim 9, wherein the first to fourth metal members have different areas.

11. The X-ray inspection device according to claim 9, wherein the third metal member has a larger area than areas of the first and second metal members.

12. The X-ray inspection device according to claim 9, wherein the fourth metal member has a larger area than an area of the third metal member.

13. The X-ray inspection device according to claim 9, wherein the fourth metal member is provided as a single fourth metal member and two overlapping fourth metal members.

14. The X-ray inspection device according to claim 9, wherein the inspector determines that the X-ray output part and the X-ray detector are aligned with each other when metal members with a same material and a same thickness have a gray value within a reference range in a second X-ray image acquired by capturing the third jig member.

15. An operating method of an X-ray inspection device, the operating method comprising:
acquiring a first X-ray image by arranging a second jig member and a battery to overlap with each other;
primarily determining whether each of an anode tab area and a cathode tab area of the battery is included within a reference pixel number in first and second regions of interest separated by a metal line of the second jig member in the first X-ray image;
secondarily determining whether metal members with a same material and a same thickness have a gray value within a reference range in a second X-ray image acquired by capturing a third jig member; and
determining that the X-ray detector and the X-ray output part are aligned with each other for X-ray imaging when primary and secondary aligning determinations satisfy criteria.
